(19) United States
(12) Patent Application Publication
(10) Pub. No.: US 2025/0354827 A1
(43) Pub. Date: Nov. 20, 2025

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventor: Mamoru TSUKAMOTO, Tokyo-to (JP)

(73) Assignee: TOYOTA JIDOSHA KABUSHIKI KAISHA, Toyota-shi (JP)

(21) Appl. No.: 19/098,424

(22) Filed: Apr. 2, 2025

(30) Foreign Application Priority Data
May 14, 2024 (JP) 2024-078847

(51) Int. Cl. G01C 21/00

(52) U.S. Cl. CPC G01C 21/3822; G01C 21/3837

(57) ABSTRACT

An information processing apparatus comprises a processor configured to: acquire, from a first vehicle, lane topology information, estimated based on data acquired via a vehicle-mounted sensor of the first vehicle, indicating a lane topology of a road traveled by the first vehicle, and first information including position information corresponding to the lane topology information, associate, based on the first information, one or more pieces of the lane topology information acquired from a plurality of the first vehicles with each of a plurality of road segments included in a road map, and determine a lane topology for each of the plurality of road segments included in the road map, based on the one or more pieces of the lane topology information that is associated.

### CROSS REFERENCE TO THE RELATED APPLICATION

This application claims the benefit of Japanese Patent Application No. 2024-078847, filed on May 14, 2024, which is hereby incorporated by reference herein in its entirety.

### BACKGROUND

### Technical Field

The present disclosure relates to map generation.

### Description of the Related Art

There is a technology for automatically generating a map. In this regard, for example, Japanese Patent Laid-Open No. 2023-149356 discloses a map generation apparatus that associates a traveling lane before entering and a traveling lane after passing based on a travel trace of a vehicle, and that associates the traveling lane before entering and the traveling lane after passing based on an external circumstance detected by a camera.

### SUMMARY

An object of the present disclosure is to add information indicating a lane of a road to a road map based on data acquired from a plurality of vehicles.

One aspect of an embodiment of the present disclosure is an information processing apparatus comprising a processor configured to:
acquire, from a first vehicle, lane topology information, estimated based on data acquired via a vehicle-mounted sensor of the first vehicle, indicating a lane topology of a road traveled by the first vehicle, and first information including position information corresponding to the lane topology information,
associate, based on the first information, one or more pieces of the lane topology information acquired from a plurality of the first vehicles with each of a plurality of road segments included in a road map, and
determine a lane topology for each of the plurality of road segments included in the road map, based on the one or more pieces of the lane topology information that is associated.

Another aspect of the embodiment of the present disclosure is an information processing method comprising:
a step of acquiring, from a first vehicle, lane topology information, estimated based on data acquired via a vehicle-mounted sensor of the first vehicle, indicating a lane topology of a road traveled by the first vehicle, and first information including position information corresponding to the lane topology information;
a step of associating, based on the first information, one or more pieces of the lane topology information acquired from a plurality of the first vehicles with each of a plurality of road segments included in a road map; and
a step of determining a lane topology for each of the plurality of road segments included in the road map, based on the one or more pieces of the lane topology information that is associated.

Furthermore, as another aspect, a program for causing a computer to perform the information processing method described above, or a computer-readable storage medium storing the program in a non-transitory manner can be cited.

According to the present disclosure, information indicating a lane of a road can be added to a road map based on data acquired from a plurality of vehicles.

### BRIEF DESCRIPTION OF THE DRAWINGS

FIG. 1 is a diagram illustrating an outline of processes performed by a server apparatus;

FIG. 2 is a diagram for describing structural elements of a server apparatus according to a first embodiment;

FIG. 3 is a flowchart of processes performed by a controller of the server apparatus according to the first embodiment;

FIG. 4 is a diagram for describing an example of arrangement of a node and an edge;

FIG. 5 is a diagram for describing information indicating an orientation of a vehicle; and

FIG. 6 is a flowchart of processes for determining a lane topology performed by a controller of a server apparatus according to a second embodiment.

### DESCRIPTION OF THE EMBODIMENTS

### Outline

An autonomous vehicle performs traveling control by using a peripheral map of a location where the autonomous vehicle is traveling.

For example, with an autonomous vehicle, a high-definition map downloaded from an external apparatus is used for autonomous driving control of the vehicle. In this case, if the high-definition map is not appropriately updated according to a current situation, autonomous driving control of the vehicle may be obstructed.

However, to update the high-definition map, a dedicated measurement vehicle has to be used, and it is costly to frequently update the high-definition map.

If the high-definition map that is difficult to frequently update is not to be used, a road map to be used instead currently does not include information that indicates a lane of a road and that is necessary for autonomous driving control. When information indicating a lane of a road or information indicating a manner of connection between lanes of a road is not added to a road map, a lane where traveling is to be performed may not be determined smoothly by autonomous driving control of a vehicle, and appropriate autonomous driving control is possibly not performed.

Accordingly, it is desirable to collect data measured by a plurality of ordinary vehicles such as connected cars instead of a dedicated measurement vehicle for generating a high-definition map, and to add information indicating a lane of a road to an existing road map based on the data.

This is because, when data measured by existing vehicles is used, it becomes unnecessary to operate a dedicated measurement vehicle to acquire data necessary for update of the high-definition map. Furthermore, by adding, based on data measured by vehicles, information about a lane that is not included in a road map that is used for autonomous driving control, smooth autonomous driving control can be achieved.

The present disclosure in its one aspect provides an information processing apparatus comprising a processor configured to:
acquire, from a first vehicle, lane topology information, estimated based on data acquired via a vehicle-mounted sensor of the first vehicle, indicating a lane topology of a road traveled by the first vehicle, and first information including position information corresponding to the lane topology information,
associate, based on the first information, one or more pieces of the lane topology information acquired from a plurality of the first vehicles with each of a plurality of road segments included in a road map, and
determine a lane topology for each of the plurality of road segments included in the road map, based on the one or more pieces of the lane topology information that is associated.

The lane topology is information indicating a topology of lanes or a topology of an object on or around a road and a lane. The object may be any of a plurality of types of objects representing specific meanings on a road map. The topology is a mathematical structure indicating a spatial relationship between target objects. That is, the topology information is information indicating a manner of coupling of lanes forming a road or a manner of coupling of an object on or around a road and a lane.

The first information includes the position information corresponding to the lane topology information. More specifically, the first information includes position information indicating which lane topology corresponding to a position on a road is indicated by a certain piece of lane topology information. Furthermore, the first information may include latitude/longitude information of the first vehicle, and information indicating an orientation of the first vehicle.

The road segment is a region, on a road map, indicating a part of a road link that is divided into a plurality of regions. For example, the road segment may be a region, on a road map, corresponding to a road between an intersection and a next intersection.

The information processing apparatus according to an aspect of the present disclosure acquires the lane topology information and the first information, and associates at least one piece of lane topology information with one road segment based on the first information. Moreover, the information processing apparatus according to an aspect of the present disclosure determines a lane topology for the associated road segment.

By acquiring the lane topology information and the first information from a plurality of vehicles, and associating the same with the road segment, accuracy of the lane topology to be added to a road map can be increased. Furthermore, by determining the lane topology of a region on a road map based on the lane topology information associated with the region, the lane topology of the region can be accurately determined without getting mixed with the lane topology information of other regions.

According to the configuration described above, the information processing apparatus according to an aspect of the present disclosure can add, to each region on a road map, information indicating an aspect of a lane of a road or a connection relationship between lanes.

Furthermore, the lane topology may express a network topology of a road in units of lanes, and the lane topology information may be information expressing a partial network topology estimated based on the data.

Furthermore, at a time of determining the lane topology for each of the plurality of road segments, the processor may dispose, on a target road segment, an edge expressing a travel line of the vehicle, and a node connecting edges.

Accordingly, the information processing apparatus according to an aspect of the present disclosure may express the lane topology using a combination of nodes that are each an end point of an edge. As described above, the information processing apparatus according to an aspect of the present disclosure can determine an appropriate travel line (track) of a vehicle by expressing the lane topology using an edge expressing a travel line of the vehicle, and a node.

Furthermore, the first information may further include latitude/longitude information of the first vehicle, and information indicating an orientation of the first vehicle.

Furthermore, the information indicating the orientation of the first vehicle may be expressed by a rotation angle of an axis parallel to a traveling direction of the vehicle from an axis of a geographic coordinate system.

Accordingly, the information processing apparatus according to an aspect of the present disclosure can accurately identify a position corresponding to lane topology information by taking into account the orientation of the vehicle at the time of acquisition of the lane topology information. The information processing apparatus according to an aspect of the present disclosure can thus add an accurate lane topology to the road map.

Furthermore, the position information corresponding to the lane topology information may be expressed by a coordinate system based on the first vehicle, and the processor may correct the coordinate system of the position information to be a geographic coordinate system by using the latitude/longitude information of the first vehicle and the information indicating the orientation of the first vehicle.

Accordingly, the information processing apparatus according to an aspect of the present disclosure may express position information corresponding to the lane topology information by a geographic coordinate system used for a road map.

In the case where the position information corresponding to the lane topology information is expressed by a coordinate system that is based on the first vehicle, the processor cannot assign the lane topology information to the road segment that is included in the road map. Accordingly, the processor may convert the coordinate system of the position information corresponding to the lane topology information to a geographic coordinate system that is used for a road map. The processor can thus assign the lane topology information to the road map.

Furthermore, in a case where there is a plurality of pieces of the lane topology information as candidates for association in relation to each of the plurality of road segments, the processor may determine the lane topology information that is to be associated, based on the number of lanes included in each piece of the lane topology information.

For example, in the case where there is a plurality of candidates for association, a majority rule based on the number of lanes indicated by each lane topology information may be applied, and the lane topology information to be associated with the road segment may be determined. This is because, when the number of lanes indicated by certain lane topology information is different from others, there is a possibility that the number of lanes is wrongly recognized. The processor can thus exclude low-accuracy lane topology information.

Furthermore, in a case where a plurality of pieces of the lane topology information is associated with each of the plurality of road segments, the processor may determine the lane topology that corresponds to the road segment, based on the lane topology indicated by the lane topology information that is randomly selected from the plurality of pieces of the lane topology information.

In a case where a plurality of pieces of the lane topology information is associated with each of the plurality of road segments, the processor may determine the lane topology that corresponds to the road segment, by using a result of combining the plurality of pieces of the lane topology information.

Combining of lane topology information may be performed by excluding lane topology information that is determined to include an error among a plurality of pieces of lane topology information, and by selecting appropriate lane topology information, for example. Moreover, combining of lane topology information may be performed by clustering a plurality of pieces of lane topology information based on a degree of similarity, and by adopting lane topology information corresponding to a cluster with largest members.

In the following, specific embodiments of the present disclosure will be described with reference to the drawings. A hardware configuration, a module configuration, a functional configuration, and the like described in each embodiment do not limit the technical scope of the disclosure thereto unless stated otherwise.

### First Embodiment

### [Outline of Processes Performed by Server Apparatus]

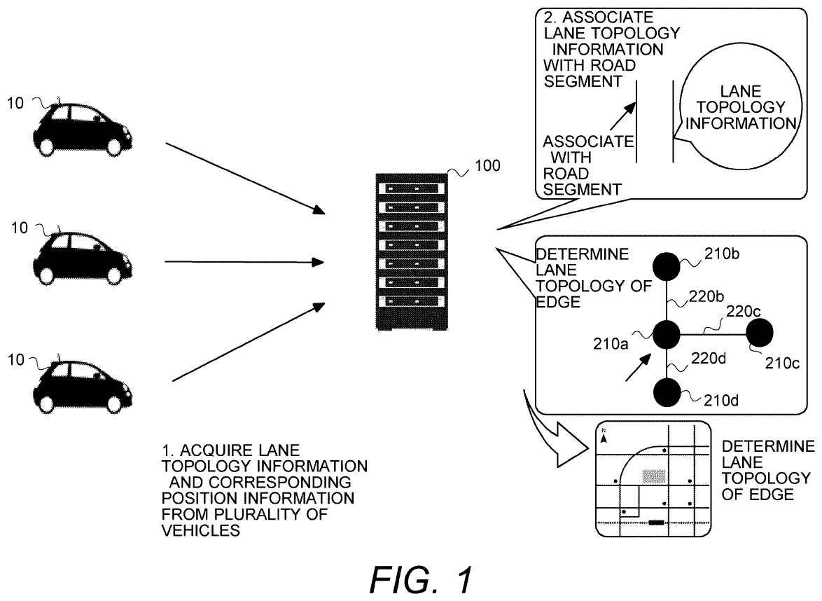

An outline of an information processing apparatus according to a first embodiment will be given with reference to FIG. 1. FIG. 1 is a diagram illustrating an outline of processes performed by a server apparatus. The information processing apparatus according to the present embodiment is implemented as a server apparatus 100, for example. The server apparatus 100 communicates with a vehicle 10, acquires various pieces of data from the vehicle 10, and updates a road map. The vehicle 10 is typically an autonomous vehicle, and is capable of communicating with an external apparatus via a wireless communication network (such as a cellular network). Additionally, the vehicle 10 is a specific example of “first vehicle”.

The vehicle 10 generates a road map in real time based on data sensed by the subject vehicle, and autonomously travels by using the road map.

A vehicle-mounted apparatus of the vehicle 10 generates, in relation to a peripheral region of the subject vehicle, a road map indicating lanes of roads, objects on roads, and connection relationships of the same. The vehicle 10 travels under autonomous driving control based on the road map. At this time, to achieve smooth autonomous driving control, the vehicle 10 preferably acquires, from outside, a road map of a region other than the peripheral region of the subject vehicle, in relation to which sensing is not performed by the subject vehicle. Furthermore, information about lanes of roads is preferably added to the road map.

Accordingly, the server apparatus 100, which is a center apparatus that communicates with the vehicle 10, generates a large road map to which information about lanes of roads is added, based on various types of data acquired from a plurality of vehicles 10. The plurality of vehicles 10 download the generated road map from the server apparatus 100 as appropriate. A vehicle 10 receiving the road map can thereby acquire a road map to which information about lanes of roads is added and that is about a region outside a range that can be sensed by the subject vehicle.

Additionally, in the case where the server apparatus 100 does not hold an existing road map, the server apparatus 100 may newly generate a road map of a region outside a surrounding region of the vehicle 10 based on various pieces of data acquired from a plurality of other vehicles 10.

First, the server apparatus 100 acquires, from a plurality of vehicles 10, lane topology information that each of the plurality of vehicles 10 acquired during traveling, and position information corresponding to the lane topology information. The lane topology information here is information indicating a partial network topology of a lane of a road traveled by each of the plurality of vehicles 10. That is, the lane topology information indicates a manner of connection of lanes of roads. Furthermore, position information corresponding to lane topology information indicates a position on a road to which the lane topology indicated by the lane topology information corresponds.

Next, the server apparatus 100 associates one piece of lane topology information with one road segment among a plurality of road segments. The server apparatus 100 associates lane topology information with a road segment at a position on a road map to which position information corresponding to the lane topology information corresponds. That is, the server apparatus 100 determines, based on position information corresponding to lane topology information, a position on a road to which a lane topology indicated by the lane topology information corresponds, and associates the lane topology information with a road segment corresponding to the position. In the case where there is a plurality of pieces of lane topology information that correspond to one road segment, one piece of lane topology information to be associated is determined by a predetermined method.

Next, the server apparatus 100 determines the lane topology for an edge included in a road segment. An edge is a line segment having two nodes as end points, and is used at a time of expressing a lane topology. A lane topology is expressed by a combination of an edge and a node. The server apparatus 100 determines a lane topology for an edge corresponding to a position of one road segment. For example, a lane topology of an edge 220b indicates that end points of the edge 220b are nodes 210a and 210b. Furthermore, the lane topology indicates that the node 210a that is an end point of the edge 220b is connected to another node 210c by an edge 220c, and is connected to a node 210d by an edge 220d. Moreover, one road segment may include a plurality of edges corresponding to a plurality of lanes, respectively. For example, in the case where a road where the vehicle 10 travels includes a plurality of lanes, and lane topology information about the plurality of lanes is acquired, a lane topology including a plurality of parallel edges may be determined for one road segment.

The server apparatus 100 determines a lane topology for each edge, and generates a road map where the lane topology information is added to each road segment.

As described above, the server apparatus 100 can add, to a road map not including the lane topology information, appropriate lane topology information that is determined based on data measured by a plurality of vehicles 10.

As described above, the server apparatus 100 can add, to a road map, information indicating a network topology of a lane of a road, based on data acquired from a plurality of vehicles. Furthermore, when the vehicle 10 acquires such a road map, the vehicle 10 can obtain information about a lane of a road also with respect to a region outside a range where the subject vehicle can perform sensing, and smooth autonomous driving control can thus be performed.

### [Configuration of Server Apparatus]

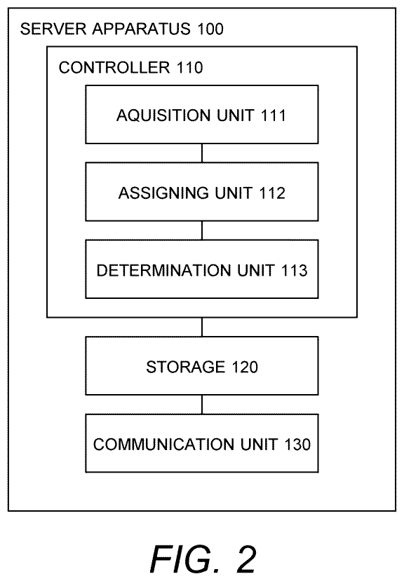

Next, a hardware configuration and a software configuration of each device forming the server apparatus 100 will be described. FIG. 2 is a diagram for describing structural elements of the server apparatus 100 according to the first embodiment.

The server apparatus 100 may be a computer including processors (CPU, GPU, etc.), main memories (RAM, ROM, etc.), and auxiliary memories (EPROM, hard disk drive, removable medium, etc.). The auxiliary memory stores an operating system (OS), various programs, various tables and the like, and each function (software module) matching a predetermined object as described below may be implemented through execution of a program that is stored therein. However, one or some or all of functions may alternatively be implemented as a hardware module by a hardware circuit such as an ASIC or an FPGA.

The server apparatus 100 includes a controller 110, a storage 120, and a communication unit 130.

The controller 110 is implemented by a processor such as a central processing unit (CPU) or a graphics processing unit (GPU), and a memory. As functional modules, the controller 110 includes an acquisition unit 111, an assigning unit 112, and a determination unit 113. These functional modules may be implemented by execution of a program by the controller 110.

The acquisition unit 111 communicates with a plurality of vehicles 10 via the communication unit 130, and acquires the lane topology information and first information. The lane topology information is information indicating a manner of connection between lanes of a road or between a lane of a road and an object on or around the road, and is information indicating a spatial relationship between lanes or between an object and a lane by using a mathematical structure. Furthermore, the first information is information including position information corresponding to the lane topology information. More specifically, the first information may include position information corresponding to the lane topology information, latitude/longitude information of the first vehicle, and information indicating an orientation of the first vehicle.

The assigning unit 112 associates the lane topology information with a road segment included in a road map, based on the first information. In the case where a plurality of pieces of lane topology information is acquired, the assigning unit 112 associates each piece with one of a plurality of road segments included in the road map. Additionally, a plurality of pieces of lane topology information may be associated with one road segment. A road segment is a region obtained by cutting out a part of a road included in the road map. For example, the road segment may be a region obtained by cutting out a road between an intersection and a next intersection.

The determination unit 113 determines the lane topology for each of a plurality of road segments included in the road map, based on at least one piece of corresponding lane topology information. The determination unit 113 determines, based on the lane topology information corresponding to a road segment determined by the assigning unit 112, the lane topology of a lane included in the road segment. The lane topology is a network topology indicating a manner of connection between lanes or between a lane and an object on the road.

The storage 120 is a main memory such as a RAM or a ROM, or an auxiliary memory such as an EPROM, a hard disk drive or a removable medium. The auxiliary memory stores an operating system (OS), various programs, various tables and the like, and each function matching a predetermined object of each unit of the controller 110 can be implemented through execution of a program that is stored therein. However, one or some or all of functions may be implemented by a hardware circuit such as an ASIC or an FPGA.

The storage 120 stores data and the like that are used or generated by processes performed by the controller 110. The storage 120 may further store the first information and the lane topology information acquired from the vehicle 10.

The communication unit 130 is a communication circuit that performs wireless communication. For example, the communication unit 130 may be a communication circuit that performs wireless communication using 4G (4th Generation) or may be a communication circuit that performs wireless communication using 5G (5th Generation). Moreover, the communication unit 130 may be a communication circuit that performs wireless communication using LTE (Long Term Evolution) or may be a communication circuit that performs communication using LPWA (Low Power Wide Area). Moreover, the communication unit 130 may be a communication circuit that performs wireless communication using Wi-Fi (registered trademark).

### [Processes of Server Apparatus]

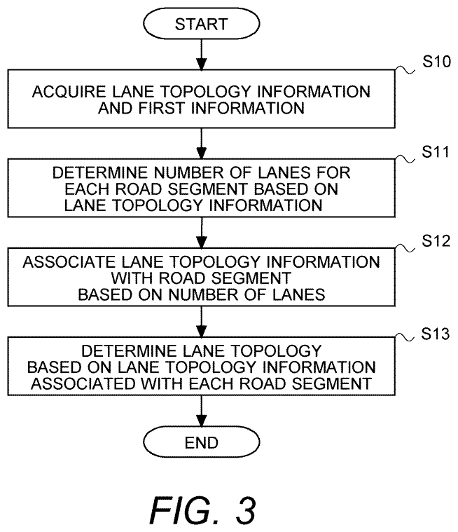

Next, details of processes that are performed by the server apparatus 100 will be described. FIG. 3 is a flowchart of processes performed by the controller 110 of the server apparatus 100 according to the first embodiment.

For example, the server apparatus 100 periodically performs processes described in FIG. 3. Alternatively, the server apparatus 100 may start the processes described in FIG. 3 when a certain request is received from a user of the vehicle 10 or the like. A certain request may be an operation for requesting download of a road map that is necessary for autonomous driving control of the vehicle 10.

First, in step S10, the acquisition unit 111 acquires the lane topology information and the first information. The acquisition unit 111 communicates with a plurality of vehicles 10 via the communication unit 130, and acquires the lane topology information and the first information from each of the plurality of vehicles 10. The acquisition unit 111 may acquire a plurality of pieces of lane topology information corresponding to a same position from each of the plurality of vehicles 10.

In step S11, the assigning unit 112 acquires the number of lanes of a target road segment based on the lane topology information. The assigning unit 112 determines, as the number of lanes of a target road segment, the number of lanes selected by a predetermined method from the numbers of lanes indicated by a plurality of pieces of lane topology information corresponding to the target road segment. The lane topology information corresponding to a target road segment is lane topology information according to which the position indicated by position information corresponding to the lane topology information and the position of the road segment substantially coincide.

The assigning unit 112 may determine, as the number of lanes of the target road segment, the number of lanes indicated by the largest number of pieces of lane topology information among the plurality of pieces of lane topology information corresponding to the target road segment.

Next, in step S12, the assigning unit 112 associates the lane topology information with the target road segment based on the number of lanes determined in step S11. Of the plurality of pieces of lane topology information corresponding to the position of the road segment, the assigning unit 112 associates one appropriate piece of lane topology information matching the number of lanes determined in step S11 with the road segment. For example, the assigning unit 112 may associate, with the road segment, lane topology information that is randomly selected from a plurality of pieces of lane topology information corresponding to the position of the road segment and matching the number of lanes of the target road segment.

Next, in step S13, the determination unit 113 determines, based on the lane topology information associated with each road segment, the lane topology corresponding to the road segment. More specifically, at the time of determining the lane topology for each of a plurality of road segments, the determination unit 113 disposes, on the target road segment, an edge indicating a travel line of the vehicle and a node connecting edges.

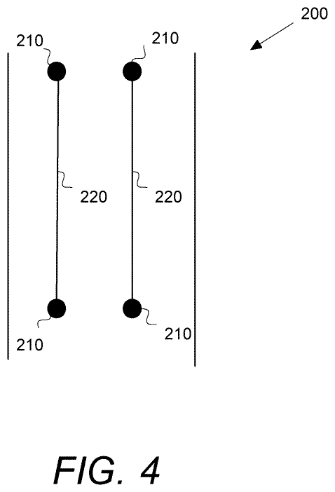

FIG. 4 is a diagram for describing an example of arrangement of the node and the edge. As illustrated in FIG. 4, the determination unit 113 disposes one or a plurality of nodes 210 on a road segment 200. In the case where a plurality of lanes is included in the road segment 200, the determination unit 113 disposes the node 210 for each lane. Then, the determination unit 113 disposes an edge 220 between two nodes 210. One edge corresponds to one lane. For example, with respect to the road segment 200 including two lanes, two edges 220, and four nodes 210 as end parts of the two edges 220 are disposed.

As described above, the determination unit 113 can determine, for each road segment, a partial network topology indicating which node is connected to which node.

In the first embodiment, the acquisition unit 111 acquires, from a plurality of vehicles 10, the lane topology information corresponding to each road segment, and the first information indicating the position with which the lane topology information corresponds. Then, the determination unit 113 determines an appropriate lane topology for each road segment, based on a plurality of pieces of lane topology information. The server apparatus 100 can thereby add information indicating a lane of a road to a road map based on data acquired from a plurality of vehicles.

### Modification of First Embodiment

In the first embodiment, the server apparatus 100 associates the lane topology information and the road segment by using the position information, included in the first information, corresponding to the lane topology information. However, position information corresponding to the lane topology information is not always in a format that can be used by the server apparatus 100. For example, position information corresponding to the lane topology information acquired from the vehicle 10 may be expressed by a coordinate system centered on the vehicle. However, position information expressed by a geographic coordinate system is sometimes necessary for generation (or update) of the road map. Accordingly, in a modification of the first embodiment, the server apparatus 100 uses the coordinate system of the position information corresponding to the lane topology information by correcting the same into a geographic coordinate system by using information, included in the first information, indicating an orientation of the vehicle.

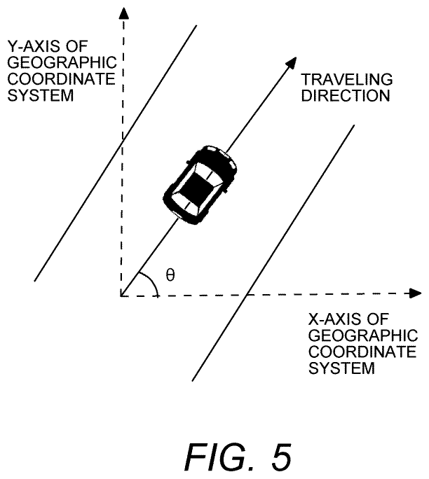

FIG. 5 is a diagram for describing information indicating an orientation of the vehicle 10. Information indicating an orientation of the vehicle 10 is included in the first information. The information indicating an orientation of the vehicle 10 is information indicating an angle by which an axis indicating a traveling direction of the vehicle 10 is inclined from an X-axis of the geographic coordinate system. Alternatively, the information indicating an orientation of the vehicle 10 may be information indicating an angle by which the axis indicating the traveling direction of the vehicle 10 is inclined from a Y-axis of the geographic coordinate system.

The assigning unit 112 corrects the coordinate system of the position information corresponding to the lane topology information from the coordinate system centered on the vehicle 10 into the geographic coordinate system, based on the latitude/longitude information of the vehicle 10 and information indicating the orientation of the vehicle 10 that are acquired by the acquisition unit 111. More specifically, coordinates of the position information corresponding to the lane topology information, expressed by the coordinate system centered on the vehicle 10, may be rotated by the angle indicated by the information indicating the orientation of the vehicle 10, and be corrected into coordinates on the geographic coordinate system.

As described above, the server apparatus 100 may use the position information corresponding to the lane topology information acquired from a vehicle to perform processing, by converting the position information into the geographic coordinate system.

### Second Embodiment

### [Outline of Processes Performed by Server Apparatus]

In the first embodiment, the server apparatus 100 associates one most appropriate piece of lane topology information among a plurality of pieces of lane topology information corresponding to the position of a target road segment with the road segment, and determines the lane topology of the road segment. However, in the case where there is a plurality of pieces of lane topology information corresponding to the position of the road segment, it is sometimes better to determine the lane topology corresponding to the position of the road segment while taking all the pieces of lane topology information into account. Accordingly, in a second embodiment, the server apparatus 100 combines a plurality of pieces of lane topology information corresponding to the position of a target road segment, selects appropriate lane topology information, and assigns the selected lane topology information to the road segment.

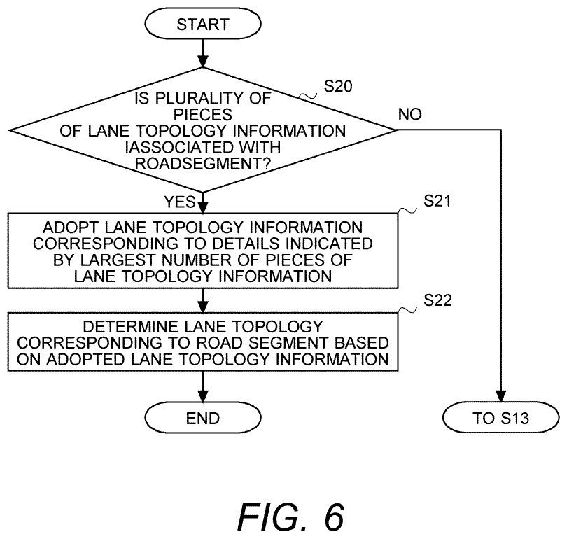

FIG. 6 is a flowchart of processes for determining a lane topology performed by the controller 110 of the server apparatus 100 according to the second embodiment. The processes described in FIG. 6 are performed instead of step S13 after the process in step S12 in FIG. 3.

First, in step S20, the determination unit 113 determines whether a plurality of pieces of lane topology information is associated with a target road segment by the assigning unit 112. A plurality of pieces of lane topology information can be said to be associated with the target road segment in a case where there is a plurality of pieces of lane topology information that match the number of lanes determined in step S11 in FIG. 3. A positive determination is made in the present step in a case where it is determined by the determination unit 113 that a plurality of pieces of lane topology information is associated with the target road segment.

In the case where the positive determination is made in the present step, the process proceeds to step S21.

In the case where a negative determination is made in the present step, the process proceeds to S13 described in FIG. 3.

In the case where the process proceeds to step S21, the determination unit 113 determines the lane topology of the target road segment by performing a process of combining the plurality of pieces of lane topology information that are associated with the target road segment.

As the process of combining a plurality of pieces of lane topology information, there may be cited a process of classifying (by clustering, for example) the plurality of pieces of lane topology information based on the lane topology, and adopting the lane topology with the largest number, for example.

For example, the determination unit 113 selects, as the lane topology information of a target road segment, the lane topology information corresponding to details indicated by the largest number of pieces of lane topology information among details indicated by a plurality of pieces of lane topology information. For example, a case where three pieces of lane topology information are associated with a certain road segment will be described. In the case where two of the three pieces of lane topology information indicate that a node 3 is connected to a node 1, and one piece of lane topology information indicates that a node 2 is connected to the node 1, the determination unit 113 may adopt the lane topology information indicating that the node 3 is associated with the node 1. That is, the determination unit 113 may adopt, for each road segment, the lane topology information indicated by the largest number of pieces of lane topology information among all the pieces of lane topology information.

Additionally, other methods may also be adopted as long as a plurality of lane topologies can be combined.

Next, in step S22, the determination unit 113 determines the lane topology corresponding to the target road segment based on the lane topology information that is adopted.

In the second embodiment, the server apparatus 100 can combine a plurality of pieces of lane topology information and can determine an appropriate lane topology for a target road segment. Accordingly, the server apparatus 100 can appropriately add information indicating a lane of a road and the like to a road map based on data acquired from a plurality of vehicles.

### Other Modifications

The above-described embodiment is just an example, and the present disclosure can be appropriately changed and implemented without departing from the spirit thereof.

The present disclosure includes an information processing method for performing the processes described in the embodiments described above, and a program for causing a computer to perform the information processing method.

The present disclosure can also be realized by supplying a computer program implementing the functions described in the above embodiment to a computer, and one or more processors included in the computer read out and execute the program. Such computer programs may be provided to a computer by a non-transitory computer-readable storage medium connectable to a system bus of the computer or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus comprising a processor configured to:
acquire, from a first vehicle, lane topology information, estimated based on data acquired via a vehicle-mounted sensor of the first vehicle, indicating a lane topology of a road traveled by the first vehicle, and first information including position information corresponding to the lane topology information,
associate, based on the first information, one or more pieces of the lane topology information acquired from a plurality of the first vehicles with each of a plurality of road segments included in a road map, and
determine a lane topology for each of the plurality of road segments included in the road map, based on the one or more pieces of the lane topology information that is associated.

2. The information processing apparatus according to claim 1, wherein
the lane topology expresses a network topology of a road in units of lanes, and
the lane topology information is information expressing a partial network topology estimated based on the data.

3. The information processing apparatus according to claim 2, wherein, the processor disposes,
at a time of determining the lane topology for each of the plurality of road segments, on a target road segment, an edge expressing a travel line of the first vehicle, and a node connecting the edges.

4. The information processing apparatus according to claim 1, wherein
the first information further includes latitude/longitude information of the first vehicle, and information indicating an orientation of the first vehicle.

5. The information processing apparatus according to claim 4, wherein
the information indicating the orientation of the first vehicle is expressed by a rotation angle of an axis parallel to a traveling direction of the vehicle from an axis of a geographic coordinate system.

6. The information processing apparatus according to claim 4, wherein
the position information corresponding to the lane topology information is expressed by a coordinate system based on the first vehicle, and
the processor corrects the coordinate system of the position information to be a geographic coordinate system by using the latitude/longitude information of the first vehicle and the information indicating the orientation of the first vehicle.

7. The information processing apparatus according to claim 1, wherein,
in a case where there is a plurality of pieces of the lane topology information as candidates for association in relation to each of the plurality of road segments, the processor determines the lane topology information that is to be associated, based on the number of lanes included in each piece of the lane topology information.

8. The information processing apparatus according to claim 1, wherein,
in a case where a plurality of pieces of the lane topology information is associated with each of the plurality of road segments, the processor determines the lane topology that corresponds to the road segment, based on the lane topology indicated by the lane topology information that is randomly selected from the plurality of pieces of the lane topology information.

9. The information processing apparatus according to claim 1, wherein,
in a case where a plurality of pieces of the lane topology information is associated with each of the plurality of road segments, the processor determines the lane topology that corresponds to the road segment, by using a result of combining the plurality of pieces of the lane topology information.

10. An information processing method comprising:
a step of acquiring, from a first vehicle, lane topology information, estimated based on data acquired via a vehicle-mounted sensor of the first vehicle, indicating a lane topology of a road traveled by the first vehicle, and first information including position information corresponding to the lane topology information;
a step of associating, based on the first information, one or more pieces of the lane topology information acquired from a plurality of the first vehicles with each of a plurality of road segments included in a road map; and
a step of determining a lane topology for each of the plurality of road segments included in the road map, based on the one or more pieces of the lane topology information that is associated.

11. The information processing method according to claim 10, wherein
the lane topology expresses a network topology of a road in units of lanes, and
the lane topology information is information expressing a partial network topology estimated based on the data.

12. The information processing method according to claim 11, wherein, in the step of determining the lane topology,
an edge expressing a travel line of the first vehicle, and a node connecting the edges are disposed on a target road segment.

13. The information processing method according to claim 10, wherein
the first information further includes latitude/longitude information of the first vehicle, and information indicating an orientation of the first vehicle.

14. The information processing method according to claim 13, wherein
the information indicating the orientation of the first vehicle is expressed by a rotation angle of an axis parallel to a traveling direction of the vehicle from an axis of a geographic coordinate system.

15. The information processing method according to claim 13, wherein
the position information corresponding to the lane topology information is expressed by a coordinate system based on the first vehicle, and
the information processing method further comprises a step of correcting the coordinate system of the position information to be a geographic coordinate system by using the latitude/longitude information of the first vehicle and the information indicating the orientation of the first vehicle.

16. The information processing method according to claim 10, wherein,
in the step of associating the lane topology information with each of the plurality of road segments included in the road map,
in a case where there is a plurality of pieces of the lane topology information as candidates for association in relation to each of the plurality of road segments, the lane topology information that is to be associated is determined based on the number of lanes included in each piece of the lane topology information.

17. The information processing method according to claim 10, wherein,
in the step of determining the lane topology,
in a case where a plurality of pieces of the lane topology information is associated with each of the plurality of road segments, the lane topology that corresponds to the road segment is determined based on the lane topology indicated by the lane topology information that is randomly selected from the plurality of pieces of the lane topology information.

18. The information processing method according to claim 10, wherein, in the step of determining the lane topology,
in a case where a plurality of pieces of the lane topology information is associated with each of the plurality of road segments, the lane topology that corresponds to the road segment is determined by using a result of combining the plurality of pieces of the lane topology information.

19. A non-transitory storage medium storing a program for causing a computer to perform the information processing method according to claim 10.
